(19) United States
(12) Patent Application Publication
(10) Pub. No.: US 2018/0055009 A1
(43) Pub. Date: Mar. 1, 2018

(54) SOOTHING GARMENT FOR PETS

(71) Applicant: Recovery Force, LLC, Fishers, IN (US)

(72) Inventors: Matthew W. Wyatt, Fishers, IN (US); Brian J. Stasey, Fishers, IN (US)

(21) Appl. No.: 15/689,376

(22) Filed: Aug. 29, 2017

Related U.S. Application Data
(60) Provisional application No. 62/380,585, filed on Aug. 29, 2016.

(51) Int. Cl. A01K 13/00; A01K 29/00

(52) U.S. Cl. CPC A01K 13/006; A01K 29/005

(57) ABSTRACT

A soothing garment for a pet includes an elongated body portion adapted to be wrapped around the torso of the pet, the body portion including flaps at the opposite ends of the elongated body portion with a fastener array for removable engagement of the flaps around the animal's torso. The body further includes a pair of forward flaps arranged to encircle the neck of the animal when the body portion is wrapped around the animal's torso. The garment includes an active compression mechanism disposed within the elongated body portion that includes an array of shape memory alloy (SMA) wires and a controller for selectively activating the SMA wire array to reduce the length of the wire to thereby apply compression to the torso of the pet.

### REFERENCE TO RELATED APPLICATION

This application is a utility filing of and claims priority to co-pending U.S. provisional application No. 62/380,585, filed on Aug. 29, 2016, the entire disclosure of which is incorporated herein by reference.

### BACKGROUND

Nearly 23 million dogs suffer from some form of anxiety, affecting 18 million households. The most prominent types of anxiety are separation anxiety and noise-related anxiety, such as fireworks and thunderstorms. The frequency and severity of anxiety attacks in dos typically increases with age, with nearly 40% of the pet dogs suffering from anxiety issues. While pet cats are less likely to suffer from similar anxieties, some cats still experience noise-related anxiety.

One common treatment has been to administer anti-anxiety drugs to the pet. This approach can be expensive and is often inconvenient since the drug must be administered well before the anxiety-stimulating event occurs in order to be effective.

A more recent development has been the ThunderShirt® sold by Thundershirt, LLC. The ThunderShirt® is a “pressure wrap”, which is a material or garment that wraps around the pet's torso, in particular the chest and sometimes the stomach, to provide a constant, gentle pressure. It is uncertain why wraps are effective, but anxiety experts such as Dr. Temple Grandin suggest that pressure has a calming effect on the nervous system. See, King, C., Buffington, L., Smith, T. J., Grandin, T., “The effect of a pressure wrap (ThunderShirt®) on heart rate and behavior in canines diagnosed with anxiety disorder”, Journal of Veterinary Behavior (2014), doi: 10.1016/j jveb.2014.06.007. Examples of using pressure to calm anxiety include pressure shirts for people with autism, squeeze chutes for cattle, pressure shirts and weighted vests for children with certain behavioral disorders, and swaddling infants. This treatment has been proven very effective for many dogs. Some wraps are homemade, for example, out of an appropriately sized t-shirt, but wraps can be difficult to put on and get the desired fit. Some conventional pressure wraps lack ease in applying the wrap and may be difficult to adjust to the right pressure.

The ThunderShirt® include a central portion, flaps extending from opposite sides of the central portion, and, in some cases, a cinching member that extends from a central area of the central portion. The flaps may be fastened together around the chest and stomach of the animal, and the cinching member may be fastened to the central portion or one or more flaps to tighten the garment further, applying pressure to reduce anxiety, fearfulness, or over-excitement. Straps may be provided to secure the garment to the animal's neck. One material that may be used in making the garment is a fabric made of 55% cotton, 35% polyester, and 10% spandex. Other details of the ThunderShirt® are disclosed in U.S. Pat. Nos. 8,291,867; 8,459,211; and 8,899,189; the entire disclosures of which are incorporated herein by reference.

The ThunderShirt® has enjoyed meaningful commercial success as a quick and ready treatment for various forms of pet anxiety. However, the design of the ThunderShirt® is such that the pressure applied by the garment is fixed and dependent on how tightly the owner wraps the garment around the pet's torso. The garment may be over- or under-tightened by the pet owner or loosened by movement of the pet, thereby impacting its performance and the comfort of the pet. There is a need for a pressure garment for pets that avoid these problems of the prior devices.

### DESCRIPTION OF THE DRAWINGS

FIG. 1 is a top view of a pressure garment according to one aspect of the present invention, with the garment shown opened in a flat plane.

FIG. 2 is a perspective view of a dog wearing the pressure garment of FIG. 1.

### SUMMARY OF THE DISCLOSURE

A soothing garment for an animal comprises an elongated body portion adapted to be wrapped around the torso of the animal, the body portion including flaps at the opposite ends of the elongated body portion with a fastener array for removable engagement of the flaps around the animal's torso. The garment further includes a pair of elongated forward flaps attached to said body portion and arranged to encircle the neck of the animal and including a fastener array for removable engagement of the forward flaps to help retain the garment in position on the animal. In one aspect, the garment includes an active compression mechanism disposed within the elongated body portion that is operable to apply compression to the animal through the garment. Tie active compression mechanism includes an anchor element disposed in each of said flaps at the opposite ends of the elongated body portion, an array of shape memory alloy (SMA) wires connected between the anchor element at the opposite ends of the body portion, and a controller for selectively activating one or more selected wire of the SMA wire array to reduce the length of the selected SMA wire to thereby apply compression to the torso of the animal through the body portion of the garment.

In other features, the garment includes a user-interface that allows the pet owner to control the operation of the controller and the active compression mechanism. The user-interface may be directly mounted on the garment or incorporated into a remote hand-held device that communicates wirelessly with the controller. The garment may be further provided with a camera in communication with the user-interface to allow the pet owner to see the pet's activity that might be indicative of some distress. Similarly, the garment may be provided with a microphone in communication with the user-interface. A speaker may be provided also in communication with the user-interface to allow the pet owner to verbally reassure the pet.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

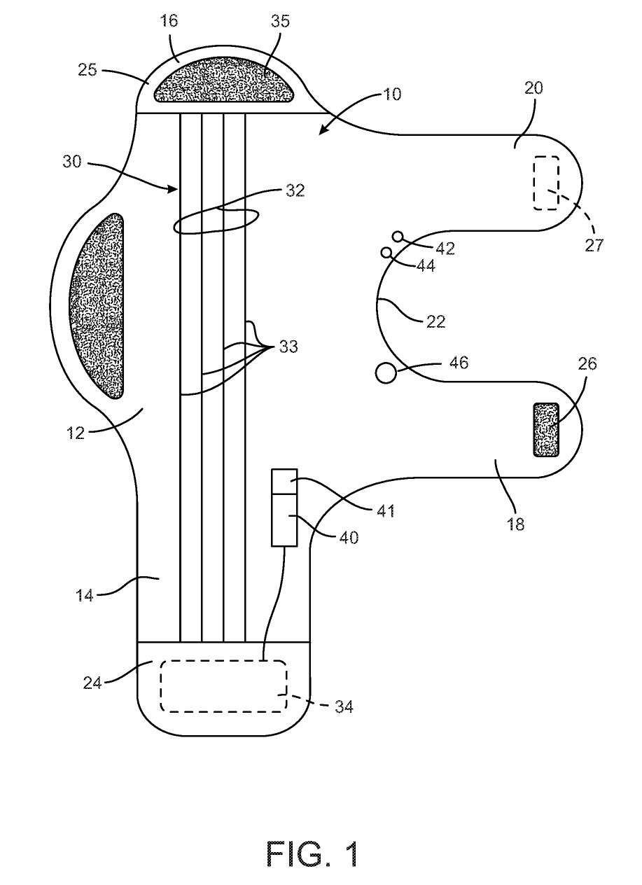

A smart soothing pet garment 10 is disclosed herein that provides an improved method of applying pressure to an animal in anxiety or distress. The garment, shown in FIG. 1, includes an elongated body portion 12 that is sized to extend around the torso of the animal. The ends of the body portion includes opposite flaps 14 and 16 that are sized and arranged to overlap when the body portion 12 and flaps 14, 16 are wrapped around the animal. A fastener array 24, 25 is provided between the flaps that can be coupled together to connect the flaps around the pet. The fastener array 24, 25 can be a hook and loop fastener, such as a couple of VELCRO® fasteners.

The body further includes forward flaps 18, 20 that define a recess 22 for receiving the pet's neck. The forward flaps 18, 20 also include similar fastener arrays 26, 27 so that the flaps can be connected around the pet's neck to hold the soothing garment in position. The garment as thus far described can be placed on the pet in a manner similar to the ThunderShirt®, except that the flaps 14, 16 that wrap around the animal's torso do not need to be as accurately connected to provide the necessary compression pressure the animal.

In one feature of the present disclosure, the garment 10 incorporates an active compression mechanism 30 that includes a shape memory alloy (SMA) wire array 32 extending from anchors 34, 35 disposed in each of the flaps 14, 15. The anchors 34, 35 may be sewn into the garment in a conventional manner so that the anchors hold their position within the garment under normal use conditions. The SMA wire array includes at least two and preferably four or more SMA wires 33 arranged to substantially encircle the torso of the pet when the garment is worn. The SMA material of the wires may be a Nitinol or Dynalloy wire that is adapted to shorten when an electric current is applied to the wire. A controller 40 is electrically connected to the wire array 32 to control which wire or wires are energized or activated, by how much and for what duration. The controller 40 can include a user-interface 41, and one or both of the controller and user-interface can be accessible on the outside of the garment. The user-interface 41 allows the pet owner to activate the controller and in some cases to control the compression protocol produced by the SMA wire array 32. Optionally, the user interface 41 may be a remote hand-held device that communicates wirelessly with the controller 40. In this embodiment, the controller can remain embedded within the garment so that it is not accessible to the pet. The user interface 41 may be a simple “on-off” switch or may incorporate a touch screen for activating the device and various compression protocols. The user interface may further include a display that shows the length of time of operation and other operating parameters of interest.

Details of the controllable compression mechanism can be found in Applicant's co-pending application Ser. No. 15/206,498, filed on Jul. 11, 2016, and entitled “Compression Device”, the entire disclosure of which is incorporated herein by reference. The controller 40 may incorporate an analog circuit including capacitors and timers that can energize the SMA wires according to a compression protocol based on the design of the circuit. Alternatively, the controller 40 includes a microprocessor operable to execute software and/or firmware commands to implement a compression protocol and/or to monitor and limit the amount of pressure applied to the pet. For instance, one compression protocol may be to apply compression for a time period, release the compression for a second time period, and then apply compression again. In another example, the individual wires of the array 32 can be selectively energized to produce a compression pattern that traverses the length of the animal's torso.

The controller 40 may thus incorporate sensors to either sense the actual amount of shortening of the wires in the wire array 32 or to sense electrical or physical characteristics of the wire array 32 indicative of the amount that the wire(s) have been shortened, and therefore the amount of pressure applied to the pet. Optionally, the controller may communicate with a pressure transducer between the garment 10 and the pet to directly measure the amount of pressure applied by the garment.

The controller 40 includes a power supply which may in the form of a rechargeable battery or conventional battery pack. The controller may also incorporate a wireless communication component, such as a wife device, that allows remote communication with and control of the garment 10. The wireless communication feature thus allows a pet owner to remotely activate the garment, such as when a thunderstorm is nearing and the pet is at home alone. The owner may thus access the controller 40 via a smart phone and app that allows the owner to not only activate the garment but also select the compression protocol and monitor the performance of the device.

The user-interface 41 may communicate, either directly or through the controller 40, with a camera 42, a microphone 44 and a speaker mounted on the garment, such as near the neck recess 22 to be close the pet's head. The camera 42 can be of the type found in the conventional “smart” phone, and can be remotely activated via the wireless communication with the controller 40, or by wireless communication directly with the user-interface 41, so that the pet owner can observe the pet's surroundings to determine if the pet's movements suggest distress. The microphone 44 can also be accessed remotely in a similar manner so that the pet owner can hear whether the pet is panting or having difficulty breathing, which may be a further indication of distress. The speaker 46 can also be accessed remotely in a similar manner to the camera and microphone to allow the owner to speak to the pet to help calm the pet. At least the microphone 44 and the speaker 46 are mounted to the garment in the vicinity of the neck recess 22 so that the components are in proximity to the animal's head. The camera 42 can also be mounted near the neck recess 22 and oriented to provide a forward view from the pet.

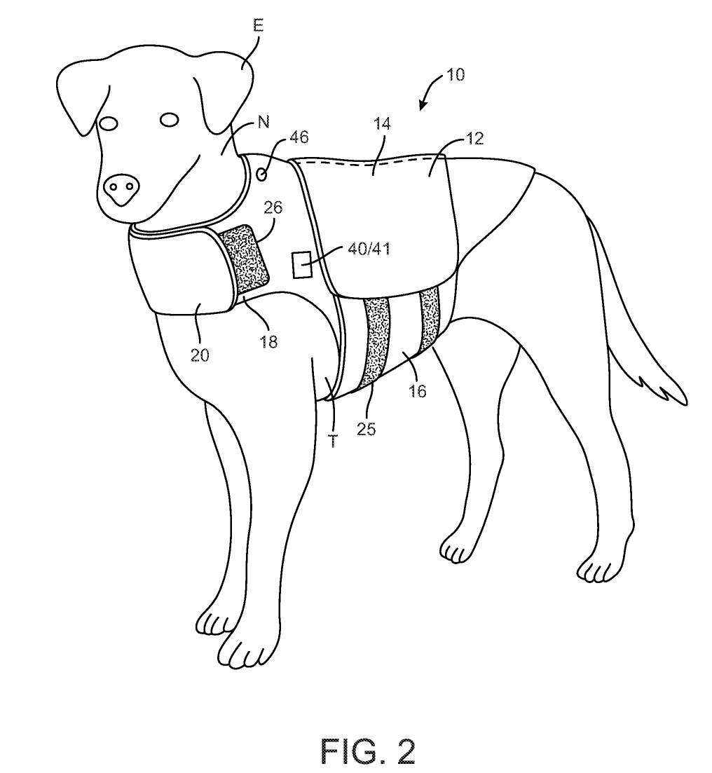

The garment 10 is shown worn by a dog in FIG. 2. The body portion 12 encircles the torso T of the dog with the flaps 14, 16 engaged tightly around the animal's body. The front flaps 18, 20 are loosely wrapped around the neck N of the dog to hold the garment in position. As shown in FIG. 2, the speaker 46 is positioned near the ear E of the dog so that the pet can hear the owner's reassuring voice. The SMA wire array 32 is not seen in FIG. 2 because the wires are embedded within the garment and adjacent the inside surface of the garment. The controller 40 and/or user-interface 41 are readily accessible at the side of the dog's body. For a wireless communication between controller and use-interface, the controller 40 would not be seen in FIG. 2 because the controller would be embedded within the garment. The users-interface 41 would be incorporated into a remote device or into the pet owner's “smart” phone.

It is contemplated that the garment 10 can be provided in several sizes and configurations to accommodate the size and type of pet. The garment itself is formed of a breathable and washable material, and preferably of a material that is water-proof or water-repellant. At a minimum, the electrical components, including the controller 40 and SMA wire array 32 are contained within a water-proof sheath so that there is no risk of compromising the compression device should the garment get wet, such as by a urination accident.

It is contemplated that the fastener arrays 24, 25 may incorporate other fasteners than the hook and loop fastener described above. For instance, the fastener arrays may include a hook and clasp arrangement, similar to a bra strap fastener array. It is also contemplated that the fastener arrays 24, 25 incorporate an additional pre-tightening device in addition to the fastener array. The pre-tightening device ensures that the garment 10 is sufficiently tight on the torso of the animal that the compression applied by the active compression device 30 actually applies meaningful compression to the animal. For instance, the fastener array may include a BOA closure sold by BOA Technology, Inc. The BOA closure utilizes a reel and spool system operable to tighten a lace, cable or wire that is wound through fittings on the component. The BOA closure may be constructed as disclosed in U.S. Pat. Nos. 7,950,112 (the '112 Patent) and U.S. Pat. No. 7,954,204 (the '204 Patent), the entire disclosures of which are incorporated herein by reference. In particular, the BOA closure may be incorporated into the hook and clasp fastener array described above. Alternatively, the BOA closure mechanism can be incorporated into the anchors 34, 35 to pull the anchors apart relative to each other, thereby applying a pre-tension to the SMA wire array. Other pre-tensioning or pre-tightening arrangements can be found in co-pending application Ser. No. 15/479,347 (the '347 Application), filed on Apr. 5, 2017 in the name of the present applicant, and entitled “Compression Device”, the entire disclosure of which is incorporated herein by reference. The arrangements disclosed in the '347 Application apply initial tension to the SMA wires themselves to ensure a snug fit on the body of the wearer, in this case a pet.

The present disclosure should be considered as illustrative and not restrictive in character. It is understood that only certain embodiments have been presented and that all changes, modifications and further applications that come within the spirit of the disclosure are desired to be protected.

What is claimed is:

1. A soothing garment for an animal comprising:
an elongated body portion adapted to be wrapped around the torso of the animal, the body portion including flaps at the opposite ends of the elongated body portion, the flaps including a fastener array for removable engagement of the opposite flaps when the body portion is wrapped around the animal's torso;
a pair of elongated forward flaps attached to said body portion and arranged to encircle the neck of the animal when the body portion is wrapped around the animal's torso, the forward flaps including a fastener array for removable engagement of the forward flaps to each other when encircling the neck of the animal;
an active compression mechanism disposed within the elongated body portion and including;
an anchor element disposed in each of said flaps at the opposite ends of the elongated body portion;
an array of shape memory alloy (SMA) wires connected between the anchor element at the opposite ends of the body portion; and
a controller for selectively activating one or more selected wire of the SMA wire array to reduce the length of the selected SMA wire to thereby apply compression to the torso of the animal through the body portion of the garment.

2. The soothing garment of claim 1, further comprising a user-interface connected to the controller for providing user activation and control of the controller.

3. The soothing garment of claim 2, wherein the controller and user-interface are connected by a wireless interface.

4. The soothing garment of claim 1, further comprising a camera mounted to the garment adjacent the forward flaps, the camera communicating with the user-interface.

5. The soothing garment of claim 1, further comprising a microphone mounted to the garment and communicating with the user-interface.

6. The soothing garment of claim 1, further comprising a speaker mounted to the garment to be positioned near the ear of the pet when the pet is wearing the soothing garment, the speaker communicating with the user-interface.
